(19) United States
(12) Patent Application Publication
(10) Pub. No.: US 2017/0169033 A1
(43) Pub. Date: Jun. 15, 2017

(54) SYSTEM AND METHOD FOR TARGETED DATA EXTRACTION USING UNSTRUCTURED WORK DATA

(71) Applicant: Dhristi Inc., Saratoga, CA (US)

(72) Inventors: Ramandeep Randhawa, Hermosa Beach, CA (US); Parag Jain, Palo Alto, CA (US)

(73) Assignee: Dhristi Inc., Saratoga, CA (US)

(21) Appl. No.: 15/379,417

(22) Filed: Dec. 14, 2016

Related U.S. Application Data
(60) Provisional application No. 62/267,237, filed on Dec. 14, 2015.

(51) Int. Cl. G06F 17/30

(52) U.S. Cl. CPC G06F 17/3053; G06F 17/3069; G06F 17/30569; G06F 17/30598

(57) ABSTRACT

According to various embodiments, a method for extracting targeted data using unstructured data is provided. The method comprises: receiving an unstructured data set, the unstructured data set includes data items from a first source and a second source; generating a first vector from the first source and a second vector from the second source, each vector includes data items in the unstructured data set; merging the first and second vectors to form a merged vector; performing clustering, using a clustering algorithm, on the merged vector in order to produce a deepness measure and a degree measure for each data item in the merged vector; generating a score for each data item in the merged vector using the deepness measure and degree measure of each data item; and ranking each data item based on its generated score.

### CROSS REFERENCE TO RELATED APPLICATIONS

This application claims priority under 35 U.S.C. §119(e) to U.S. Provisional Application No. 62/267,237, filed Dec. 14, 2015, entitled SYSTEM AND METHOD FOR EXTRACTING USER'S TOPICS OF INTEREST USING UNSTRUCTURED WORK DATA, the contents of which are hereby incorporated by reference.

### TECHNICAL FIELD

The present disclosure relates generally to computer systems, and more specifically to unstructured data systems.

### BACKGROUND

Systems have attempted to use various techniques for topic modeling using network flows and electronic data items. Current systems for topic modeling depend mainly on frequency of data items, which work well for structured data, but are not very effective with unstructured data, like email, or even structured data with a lot of “noise.” In addition, topic modeling from unstructured data sets presents problems because there are no specific formats for unstructured data. Thus, there is a need for an improved method for extracting targeted data using unstructured data sets.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for extracting targeted data using unstructured data. According to various embodiments, a method for extracting targeted data using unstructured data is provided. The method comprises: receiving an unstructured data set, the unstructured data set includes data items from a first source and a second source; generating a first vector from the first source and a second vector from the second source, each vector includes data items in the unstructured data set; merging the first and second vectors to form a merged vector; performing clustering, using a clustering algorithm, on the merged vector in order to produce a deepness measure and a degree measure for each data item in the merged vector; generating a score for each data item in the merged vector using the deepness measure and degree measure of each data item; and ranking each data item based on its generated score.

In another embodiment, a system for extracting targeted data using unstructured data is provided. The system includes one or more programs comprising instructions for receiving an unstructured data set, the unstructured data set includes data items from a first source and a second source; generating a first vector from the first source and a second vector from the second source, each vector includes data items in the unstructured data set; merging the first and second vectors to form a merged vector; performing clustering, using a clustering algorithm, on the merged vector in order to produce a deepness measure and a degree measure for each data item in the merged vector; generating a score for each data item in the merged vector using the deepness measure and degree measure of each data item; and ranking each data item based on its generated score.

In yet another embodiment, a non-transitory computer readable storage medium is provided. The computer readable storage medium stores one or more programs comprising instructions for receiving an unstructured data set, the unstructured data set includes data items from a first source and a second source; generating a first vector from the first source and a second vector from the second source, each vector includes data items in the unstructured data set; merging the first and second vectors to form a merged vector; performing clustering, using a clustering algorithm, on the merged vector in order to produce a deepness measure and a degree measure for each data item in the merged vector; generating a score for each data item in the merged vector using the deepness measure and degree measure of each data item; and ranking each data item based on its generated score.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of a computer system, in accordance with one or more embodiments.

FIG. 2 illustrates an example of a cluster tree, in accordance with one or more embodiments.

FIG. 3 illustrates a flow chart of an example algorithm, in accordance with one or more embodiments.

FIG. 4 illustrates a flow chart of an example method for topic modeling, in accordance with one or more embodiments.

FIG. 5 illustrates one example of a topic modeling system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, techniques and mechanisms are provided to extract targeted data from unstructured user generated data, such as emails, chat, social media etc. The system extracts data items in their context, and clusters them to identify targeted data items of interest for topic modeling. The system works effectively on unstructured and noisy data, where targeted data items are surrounded by many generic and less relevant data items. In addition, the system works in a completely unsupervised manner, i.e., without any user input.

### Example Embodiments

The web (or “World Wide Web”) is a system of interlinked hypertext documents (i.e., web pages) accessed via the Internet using URLs (i.e., Universal Resource Locators) and IP-addresses. The Internet is composed of machines (e.g., computers or other devices with Internet access) associated with IP-addresses for identifying and communicating with each other on the Internet. The Internet, URL, and IP-addresses are well known to those skilled in the art. The machines composing the Internet are called endpoints of the Internet. Internet endpoints may act as a server, a client, or a peer in the communication activity on the Internet. The endpoints may also be referred to as hosts (e.g., network hosts or Internet hosts) that host information as well as client and/or server software. Network nodes such as modems, printers, routers, and switches may not be considered as hosts. Throughout this disclosure, a host is also referred to as a host device, which contains a hardware component.

Generally, a flow (or traffic stream) between two network hosts is a series of data records (referred to as packets or data packets) regarding the communication between the two network hosts engaged in an Internet transaction. The Internet transaction may be related to completing a task, which may be legitimate or malicious. Each packet includes a block of data (i.e., actual packet content, referred to as payload) and supplemental data (referred to as header) containing information regarding the payload. Each flow is referred to as attached to each of the two hosts and is uniquely defined by a 5-tuple identifier (i.e., source address, destination address, source port, destination port, and transport protocol). Specifically, each packet in a flow includes, in its header, the 5-tuple identifier of the flow. Throughout this disclosure, the terms “traffic flow”, “flow”, “traffic stream” and “stream” are used interchangeably and may refer to a complete flow or any portion thereof depending on the context unless explicitly stated otherwise.

Further, the term “transport protocol” refers to a protocol associated with or based on top of a transport layer of a computer network. For example, the transport protocol may be referred to as layer-four protocol with respect to the OSI model (i.e., Open Systems Interconnection Reference Model of the network architecture). Examples of layer-four protocols include TCP (i.e., transmission control protocol), UDP (i.e., user datagram protocol), etc.

Further still, the term “application” or “network application” refers to an application associated with or based on top of an application layer of a computer network while the term “signature” or “packet content signature” refers to an application layer packet content based signature. For example, the network application may be referred to as layer-seven application with respect to the OSI model. Examples of layer-seven applications includes HTTP (HyperText Transfer Protocol), SMTP (Simple Mail Transfer Protocol), IRC (Internet relay chat), FTP (File Transfer Protocol), BitTorrent®, GTALK® (a registered trademark of Google, Inc., Mountain View, Calif.), MSN® (a registered trademark of Microsoft Corporation, Redmond, Wash., etc.). Layer-seven applications may also be referred to as layer-seven protocols.

Packet capture is the act of capturing data packets crossing a network. Partial packet capture may be performed to record headers without recording the total content of corresponding payloads. Deep packet capture may be performed to capture complete network packets including packet header and complete packet payload. Once packets in a flow, or a portion thereof, are captured and stored, deep packet inspection may be performed to review network packet data, perform forensics analysis to uncover the root cause of network problems, identify security threats, and ensure data communications and network usage complies with outlined policy. Throughout this disclosure, a complete network packet including packet header and complete packet payload may be referred to as a full payload packet while the complete packet payload may be referred to as a full packet payload. The term “payload” may refer to full packet payload, partial packet payload, a collection of full/partial packet payloads within a flow or a portion thereof, in an interchangeable manner depending on the context unless explicitly stated otherwise.

In various embodiments, data items can be data packets from network flows as described above. In some embodiments, receiving the data items includes packet capturing as described above. In some embodiments, receiving the data items includes retrieving the items from a repository.

In some embodiments, targeted data can be extracted via inference based on other data (unstructured and structured) in a plurality of data items. Such inferences can be made by analyzing specific data items, such as email or all sorts of packets from network flows. In some embodiments, unstructured data such as personalized communications, e.g. blogs, chats, and social media are also analyzed. In various embodiments, systems analyze as much as 10,000 data items or more in order to extract an “overall” interest of a user as targeted data.

Generalized Overview of Algorithm

As used herein, “words” will be used interchangeably with “data items” or “data elements” even though “words” only represent one example of “data items,” which can include other types of data, or even metadata, found in network flows. In some embodiments, systems use frequency count to show “intensity,” or importance, of a topic. However, often times, frequency of a word or data item is not sufficient for determining the intensity of a particular topic because often times a user can use multiple different words, but with similar meaning, to talk about a topic. For example, if a person talks frequently about “bread,” but always uses other forms of the word, e.g. “sourdough,” “ciabatta,” “Dutch crunch,” etc., then frequency of each of the similar words would not demonstrate the actual intensity of the topic “bread.”

Thus, in some embodiments, the system uses a dimensional space approach. In some embodiments, data elements in a data set are “squeezed” into a dimensional space based on certain characteristics of the data set. If elements are close/similar in meaning, then they appear closer in the dimensional space. In such embodiments, a lot of data is needed because otherwise a sample space is too small and the system will confuse words that are actually opposite in meaning to be “similar.” For example, with a small sample space, the system may confuse “love” and “hate” as similar words because they are generally used in the same context (“I love you” and “I hate you”). However, with a large enough sample space, the system can actually discern such a difference. Thus, determining the intensity of a topic often requires a large enough sample size/space and usually does not work very well on “limited data.” However, emails count as “limited data,” so in order to accurately determine the intensity of topics in emails, different techniques may be employed.

In various embodiments, a method for determining the intensity of a topic (topic modeling) starts with a data set, e.g. a plurality of emails. The emails are analyzed and parsed. Then data elements of data files, such as emails, are placed into vectors, also known as generating vector representation of the data items. In some embodiments, a second vector representation is generated, but on a different source. The second vector representation is run on a global knowledge base source, e.g. Wikipedia. In some embodiments, the reason for having two vector representations with a global source and a personal source (email) is to augment the universal/general meaning of a word (from Wikipedia or some other encyclopedic/dictionary source) with a user's own specialized meaning (extrapolated from the context of the emails).

In various embodiments, once the two vectors have been generated, then the system merges/concatenates them. In some embodiments, both vectors are multi-dimensional vectors, and thus merging two multi-dimensional vectors yields a multi-dimensional vector, with each dimension being another multidimensional vector.

In various embodiments, the system then runs a clustering algorithm on the merged vector. In some embodiments, the clustering algorithm can be any standard clustering algorithm. In some embodiments, the result of the clustering algorithm yields a tree representation of words in the data set. In some embodiments, the tree has roots, and the “deepest” roots (words) are identified. In some embodiments, the “deepness” of a word correlates with how “specific” an element is. For example, “love” is a more general term and encompasses “lust.” Hence, “love” would not be represented as deeply in the tree as “lust.”

In some embodiments, the clusters with the highest density are the clusters with the deepest words. For example, a deepest word for a person could be “processor,” because the person works with computers and is constantly talking about processors or similar computer topics.

In some embodiments, the idea is to count the frequency/density of “similar words,” in order to determine the intensity of a topic. However, in some embodiments, the deepest words do not necessarily translate into real meaning for a user. This can be due to the fact that some of the deepest words can be very technical words. Thus, in various embodiments, the system also measures a “degree” of a word. A degree measure of a word can mean: for every word, how many unique words are also used with the word. For example, given the two sentences: “I love you,” and “You love hotdogs,” the word love is associated with three unique words. So the degree measure for love, in the limited example above, is three.

In various embodiments, the degree measure can yield a very high number, because there can be many unique words used with a certain word if the data set is large. Similarly, for a deepness measure, the value can also be quite large. Thus, in order to scale down the degree and deepness measures into workable values, the system may normalize both numbers.

In various embodiments, one method for normalizing the deepness measure is to scale to the measure to a percentage. Thus, all values for the deepness measure are given on a scale between 0 and 1, with 1 being a hundred percent.

In various embodiments, one method for normalizing the degree measure is to take the log of the absolute value of the degree measure and then scale the log value by a max log value. That way, for highly skewed data, normalization offers workable values for practical implementation.

In various embodiments, the normalized values are also power transformed in order to bring the medians of both values into close proximity. The reason for this is because the medians for both the degree and deepness will probably be in different parts of the scale. Thus, power transforming is necessary to bring the two medians within proximity of each other in order to have a meaningful comparison. Otherwise, in some embodiments, the degree measures will over power the deepness measure. For example a non-power transformed normalized degree median may equal 0.7, and a non-power transformed normalized deepness median may be 0.2. Thus, degree may always overpower the deepness measure in the example represented above. Thus, the system power transforms both normalized medians in order to bring both values to 0.5. One method of doing this is to either take the square or take the square root of the value.

After power transforming the normalized values, the numbers are added to form a score. In some embodiments, every word in the data set is assigned a score. In some embodiments, the scores are used to assign a rank to the words. The rank of a word tells the intensity of the word relative to the user.

In some embodiments, the scored words are ranked and then matched to different topics, for example via clustering. In some embodiments, because a topic is just a set of words that have similar meaning, each cluster may represent a topic. In some embodiments, in order to determine the topic that is most interesting to a user, the scores in each cluster/topic are then added up and the highest scores for each cluster/topic is labeled the topic of most interest. Now that a generalized overview of an example algorithm has been explained, a specific example implementation of an algorithm is presented, in accordance with various embodiments of the present disclosure.

Specific Example Implementations of Algorithm

For the purposes of this specific example, a user's email will be the user's dataset. The example algorithm involves the following steps:

First, compute a high-dimensional distributed vector representation for each word in a user's vocabulary. In some embodiments, traditional NLP techniques treat words as atomic units, and represent them as 0/1 indices in the vocabulary—there is no notion of similarity between words. In some embodiments, techniques use a distributed vector representation of words to capture their semantic and syntactic meaning. These vectors are learned from huge datasets with billions of words, and with millions of words in the vocabulary, and are typically in 100-1000 dimension space. These vectors are such that similar words tend to be close to each other in space, and their cosine distance is a good measure of semantic similarity. However, because a user's dataset is typically much smaller, usually a million words or less, and is not enough to learn a high dimensional vector that captures their full meaning, the algorithm includes learning two different vector representations for each word: a global word vector and a personalized vector. The global vector is learned from public datasets, such as Wikipedia, that captures the generic meaning. In this particular example, the system uses 300 dimension vectors for the public dataset. The personalized word vector is learned from the user's dataset, that captures the meaning in their context. In this particular example, the system uses 25 dimension vectors.

The system then concatenates these two vectors to generate a 325 vector representation for each word. Personalized vectors have the desired effect of taking words that frequently co-occur in a user's context, and are reasonably close in global vector space, and pull them closer to form dense clusters—these groups of words represent a user's topics of interest.

Next, the system generates a topic score for each word—this is a combination of two distinct concepts, depth and degree. For depth: the system performs Agglomerative Clustering on all the user's words, using the 325 dimensional vector representation for each word. As a note, each unique noun in the user's vocabulary is represented as a point in 325 dimensional space. Then, the system performs clustering on these words.

In various embodiments, clustering methods work by grouping similar points. Instead of simply outputting groups of words or points, agglomerative clustering creates a tree structure called a dendrogram as follows: first, an empty tree is initialized and then the overall closest two points are picked and added to the tree (the two points are the leaf nodes of the tree) and these are joined together at a root node (which is a dummy node, and has the position of the center of the two points joined). This process repeats and the entire tree is created. At the end of this construction, the tree has one overall root node, at which all branches merge, and all words/points are represented by leafs of the tree. In some embodiments, the depth measure of a word is defined by the length of the path from the overall root node of the tree to the word.

In some embodiments, words that are important to a user should contain many words that have similar meaning. For instance, for a developer, there would be many words such as “Javascript, Node.js, PHP, HTML . . . ,” that have similar meanings (relative to all English words). So, when doing the Agglomerative Clustering, the branches of the tree with these words will be very long, and this will be reflected in the depth of these words being high. As a note, some higher level words such as “programming” or “developing” may not have high depth. Thus a degree measure is also included.

For degree: the notion of degree is used in graph theory (a graph depicts relationships between entities represented as nodes using edges that connect the nodes). For example, social networks use graph theory extensively to represent relationship between people; the Google PageRank algorithm applied graph theory to web-pages to identify the most important web-page based on search queries.

In various embodiments, the system builds a graph using the user's data. In particular, the algorithm defines as nodes: all words in the user's vocabulary, and then for each sentence in the user's data, the algorithm considers all words used in the sentence to be connected via edges. The degree of a word in this graph is defined as the number of neighbors the word has. Equivalently, the degree of a node/word is the number of edges that leave the node/word.

In some embodiments, words have high degree if they have many neighbors, i.e., they are used along with many different words. This can be interpreted as the words being used in many different contexts. Thus, words with high degree can be construed as topical words.

For combining degree and depth: In some embodiments, degree and depth capture different aspects of importance. For a word, high depth implies that it belongs close to important words, and high degree implies that this is a topical word. So, by combining these two measures, the system captures the important topics of the user. In some embodiments, degree and depth are very different measures. As an example, the highest depth tends to be between 30 and 70, whereas the highest degree is typically in several thousands. Further, the spread of these two scores across different words is also very different. Most words have very low degree, in the single digits, and a handful of words can have a degree of several thousand. Thus, to combine the two measures, the system normalizes them.

Normalization Formulae: First, the system normalizes depth by dividing by the largest value. Next, the system takes a Logarithmic Transformation of degree, by taking the natural logarithm of degree +1 for each word (adding 1 is standard and is done to deal with zero degree words, so their natural logarithm is well defined). Then, the log is divided by natural logarithm of max_degree +1.

Next, a power transformation is performed on both depth and degree to ensure their medians are the same. Thus, in some embodiments, the [Score=f(depth,degree)].

Last, in order to identify important topics, the system performs K-means clustering with K=10. This means that the system takes all words in the user's vocabulary and clusters them into K=10 groups. Because the grouping is by similarity, this gives 10 topics of potential interest to the user. The topic score is then calculated for each of the ten topics by summing the score of each of the words that belong to that topic. The topic with the highest score is ranked as the one that is most important to the user, and the one with the second highest score as the one that is second in importance, and so on. Thus, a specific example algorithm is provided. Next, a detailed description of the figures is provided.

### DETAILED DESCRIPTION OF THE FIGURES

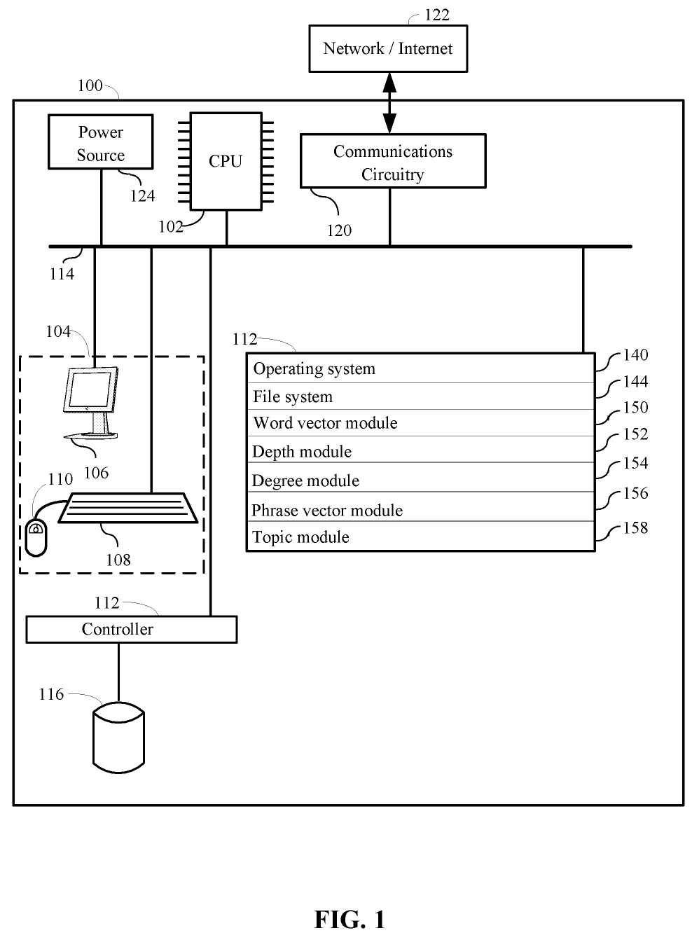

FIG. 1 is a block diagram illustrating an example of a computer system capable of implementing various processes described in the present disclosure. The system 100 typically includes a power source 124; one or more processing units (CPU's) 102 for executing modules, programs and/or instructions stored in memory 112 and thereby performing processing operations; one or more network or other communications circuitry or interfaces 120 for communicating with a network 122; controller 112; and one or more communication buses 114 for interconnecting these components. In some embodiments, network 122 can be the another communication bus, the Internet, an Ethernet, an Intranet, other wide area networks, local area networks, and metropolitan area networks. Communication buses 114 optionally include circuitry (sometimes called a chipset) that interconnects and controls communications between system components. System 100 optionally includes a user interface 104 comprising a display device 106, a keyboard 108, and a mouse 110. Memory 112 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 112 may optionally include one or more storage devices 116 remotely located from the CPU(s) 102. Memory 112, or alternately the non-volatile memory device(s) within memory 112, comprises a non-transitory computer readable storage medium. In some embodiments, memory 112, or the computer readable storage medium of memory 112 stores the following programs, modules and data structures, or a subset thereof:
an operating system 140 that includes procedures for handling various basic system services and for performing hardware dependent tasks;
a file system 144 for storing various program files;
a word vector module 150 that takes as input a corpus of structured or unstructured data and returns as output a high-dimensional vector for each word in the input corpus;
a depth module 152 that takes as input a set of words along with their high-dimensional vectors and outputs a depth score for each word;
a degree module 154 that takes as input an unstructured corpus of words, with each sentence delineated—it outputs a degree score for each word;
a phrase vector module 156 that takes as input an unstructured corpus of words and their vector representations, and generates vector representations for phrases of consecutive and/or non-consecutive words;
a topic module 158 that takes as input a set of words along with their high-dimensional vectors (from module 150), their depth score (from module 152), their degree score (from module 154) and a set of phrases along with their high-dimensional vectors (from module 156). The module outputs different sets of words and phrases, each such set represents a topic of interest for the user. Further, the topics are ranked in terms of importance to user, and within each topic, the words and phrases are ranked based on importance.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 112 may store a subset of the modules and data structures identified above. Furthermore, memory 112 may store additional modules and data structures not described above.

Although FIG. 1 shows a “system for extracting a user's topics of interest,” FIG. 1 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 1 could be implemented on single servers and single items could be implemented by one or more servers. The actual number of servers used to implement a topic modeling system and how features are allocated among them will vary from one implementation to another, and may depend in part on the amount of data traffic that the system must handle during peak usage periods as well as during average usage periods.

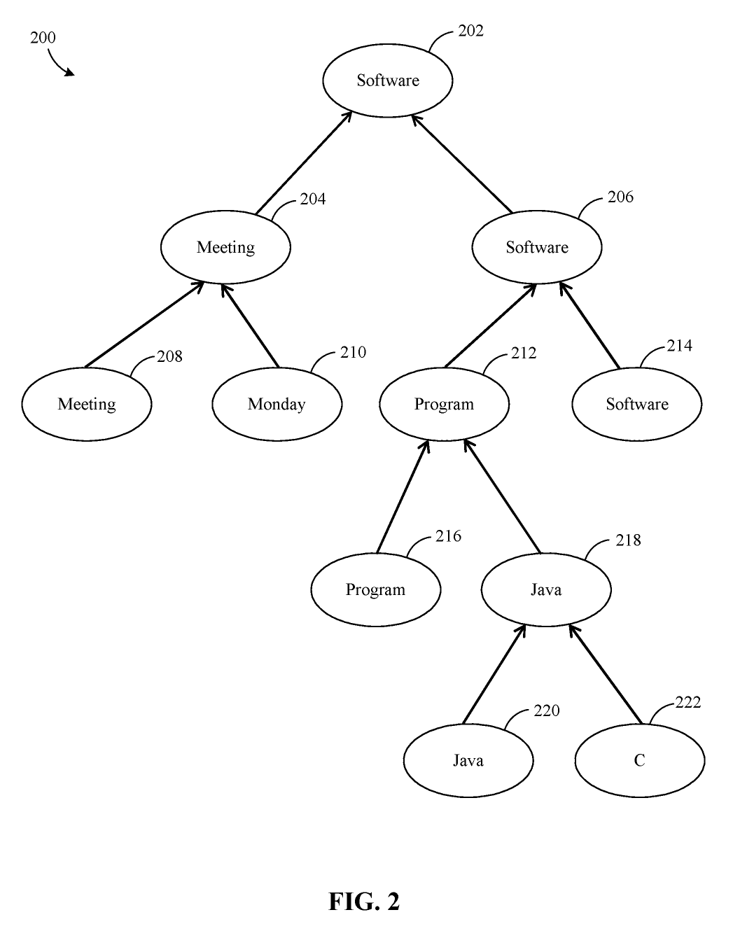

FIG. 2 illustrates an example of a cluster tree, in accordance with one or more embodiments. FIG. 2 depicts the output of the clustering module 200. This output is in the form of a tree, in which the “terminal” or “leaf” nodes are: 208, 210, 214, 216, 220, and 222. When given an input set of words, the clustering module works in the following steps:

It starts by putting every word into its own cluster—it then locates the words that are closest to each other in high-dimensional vector space and merges them into a cluster. The measure of this distance can be defined appropriately. In this example, the two closest words are 220 (Java) and 222(C). These nodes are merged into a higher level node: 218, and a label is given to the node.

This process is iteratively repeated until all nodes are merged: 208 and 210 merge into 204, 216 and 218 merge into 212, 212 and 214 merge into 206 and finally, 204 and 206 merge into 202. The top-most node, 202, is the root node of the tree.

The labels for each of the non-leaf nodes (202, 204, 206, 212, 218) are computed by the following two steps:

First, a vector is computed for each node—it is the weighted average of word vectors of all leaf nodes found in the subtree below the node. For example, the vector for node 204 is the weighted average of the vectors of 208 and 210. The vector for 212 is the weighted average of 216, 220 and 222.

Second, a label is given for each node. The label for each node is the leaf node (among those that are in the subtree below this node) which is closest to the node. Ties can be broken in any chosen manner So, for node 212, the vector of 216 is closest to the vector of 212, and hence the label for 212 is program, which is the label for node 216.

The depth of a word is defined as the length of the path from the leaf nodes to the root of the tree. For example, nodes 220 and 222 have the highest depth, as they take 4 hops to get from the leaf to the root of the tree.

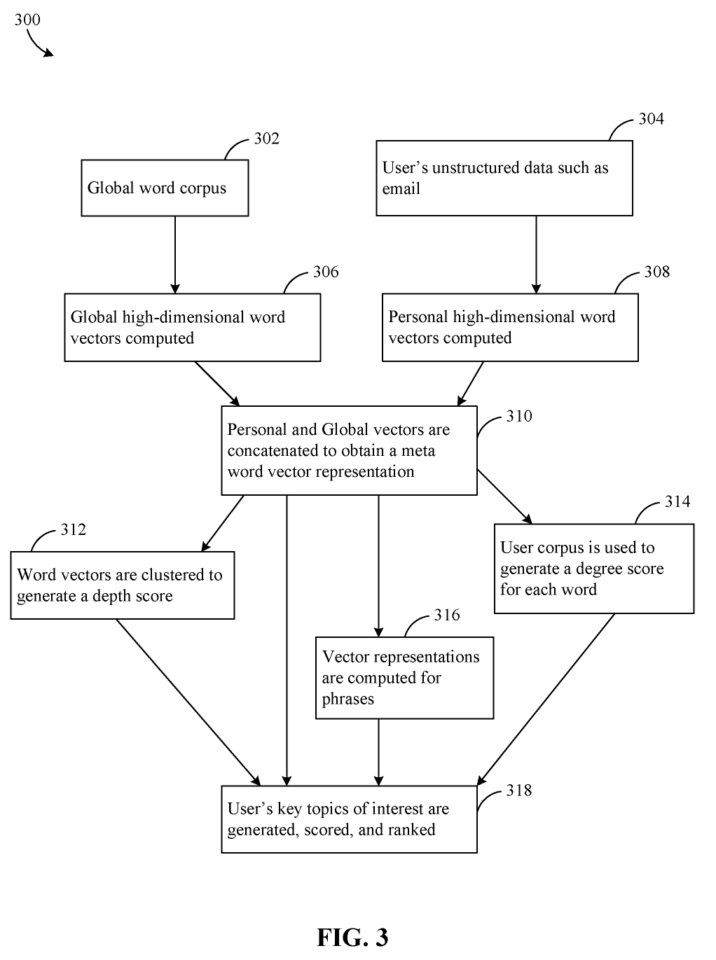

FIG. 3 illustrates a flow chart of an example algorithm, in accordance with one or more embodiments. The algorithm 300 involves the following steps:

At 302, the system takes a global word corpus with billions of words, and millions of unique words in the vocabulary. This corpus includes public datasets such as Wikipedia and others.

At 306, the system uses the word vector module (150) from FIG. 1 to learn a high-dimensional distributed vector representation for each global word. The global vectors capture the generic meaning of words, such that similar words tend to be close to each other in vector space, and their cosine distance is a good measure of semantic similarity.

At 304, the system takes a personal word corpus—this captures user generated data such as email, chat, social media etc. This corpus is usually smaller, of the order of millions of words, with 10 s of thousands of words in the vocabulary.

At 308, the system uses the word vector module (150) from FIG. 1 to learn a high-dimensional distributed vector representation for each word in the personal corpus. These personal vectors tend to capture the meaning in a user's context, and tend to be smaller in dimension than their global counterparts.

At 310, the global and personal vectors for a given word are concatenated to obtain a meta-word vector representation. This step has the desired effect of taking words that frequently co-occur in a user's context, and are reasonably close in global vector space, and pull them closer to form dense clusters - these groups of words represent a user's topics of interest.

At 312, the meta-word vectors are fed to the depth module (152) of FIG. 1—this module performs Agglomerative clustering of all the word vectors based on cosine distance, and generates a tree structure, as illustrated in FIG. 2, where all words are leaf nodes and cluster towards the root. It outputs a depth score for each word, which is defined as the length of the path from the word to the root of the tree. The intuition is that key topics will have several words with similar meaning—hence the branches of the tree with these words will be very long, and hence their depth will be high.

At 314, the user word corpus is fed into the degree module (154)—this module outputs the degree score for each word. The degree of a word is defined as the number of neighbors it has in a given context window—topical words will have high degree as they have many neighbors, and are being used in many different contexts.

At 316, the system uses the phrase vector module (156) to learn vector representations for varying length phrases that includes consecutive/ non-consecutive noun phrases. The intuition here is that topics are best described as noun phrases—these nouns generally show up at varying distances within a context window. This module learns the vector representations of these phrases, and acts as input to the topic module.

At 318, the system uses the topic module (158) to determine the topics by importance to the user, and for each topic define the keywords and key phrases that best describe it. First, the system scores each word as a function of depth and degree—the system then clusters the words into topic clusters, and rank each topic based on the score of the words that belong to it. For each topic, the system ranks the words and phrases that are the most relevant based on the score of the words, and the depth of the phrases containing those words. The output is a list of user topics with keywords and key phrases—these can be used for various information retrieval tasks.

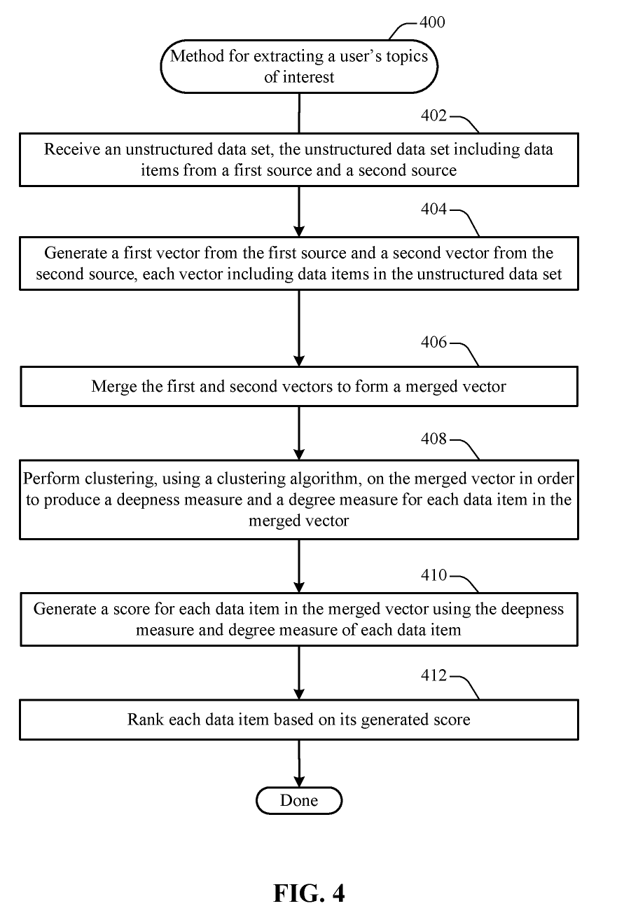

FIG. 4 illustrates a flow chart of an example method 400 for topic modeling, in accordance with one or more embodiments. Method 400 for extracting targeted data using unstructured data begins with receiving 402 an unstructured data set. In some embodiments, the unstructured data set is a plurality of emails from a user. In some embodiments, the unstructured data set includes data items from a first source and a second source. In some embodiments, the first source is a global source, e.g. Wikipedia. In some embodiments, the second source is a personal source, such as the emails.

At 404, the method includes generating a first vector from the first source and a second vector from the second source. In some embodiments, each vector includes data items in the unstructured data set. At 406, the method includes merging the first and second vectors to form a merged vector. Next, at 408, the method includes performing clustering, using a clustering algorithm, on the merged vector in order to produce a deepness measure and a degree measure for each data item in the merged vector. At 410, the method includes generating a score for each data item in the merged vector using the deepness measure and degree measure of each data item. Finally, at 412, the method includes ranking each data item based on its generated score.

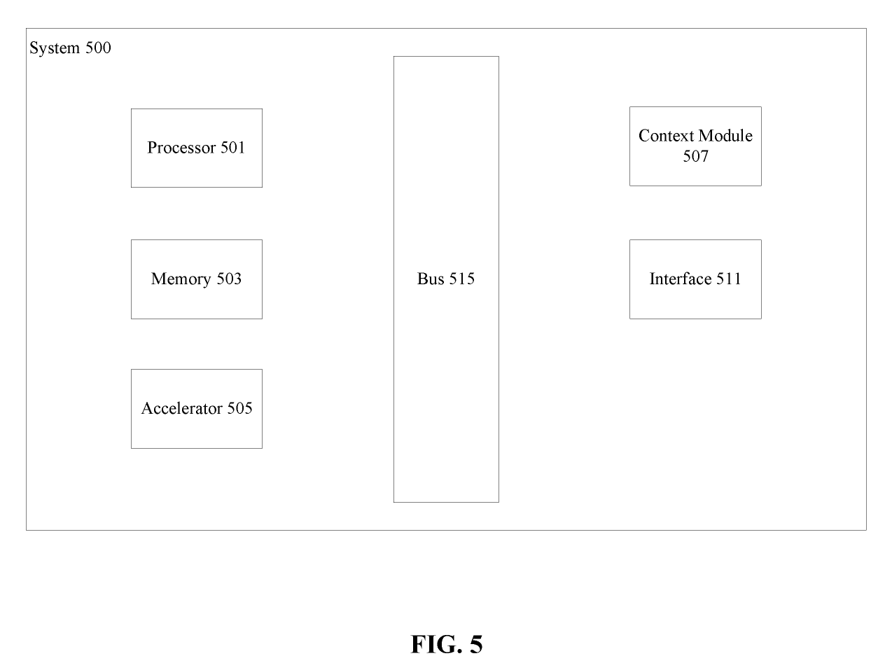

FIG. 5 illustrates one example of a topic modeling system 500, in accordance with one or more embodiments. According to particular embodiments, a system 500, suitable for implementing particular embodiments of the present disclosure, includes a processor 501, a memory 503, an interface 511, and a bus 515 (e.g., a PCI bus or other interconnection fabric) and operates as a streaming server. In some embodiments, when acting under the control of appropriate software or firmware, the processor 501 is responsible for various processes, including processing inputs through clustering algorithms. Various specially configured devices can also be used in place of a processor 501 or in addition to processor 501. The interface 511 is typically configured to send and receive data packets or data segments over a network.

In some embodiments, system 500 further comprises context module 207 configured for extracting and determining the context for data items as described in more detail above. Such a context module 207 may be used in conjunction with accelerator 505. In various embodiments, accelerator 505 is an additional processing accelerator chip. The core of accelerator 305 architecture may be a hybrid design employing fixed-function units where the operations are very well defined and programmable units where flexibility is needed. In some embodiments, context module 507 may also include a trained neural network to further identify correlated data items in unstructured data. In some embodiments, such neural networks would take unstructured data and specified data items in the unstructured data as input and output correlation values between the data items.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions for operations mentioned above with reference to method 400. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

In some embodiments, advantages provided by the system and methods described above include automatically extracting targeted information from unstructured data. As a result, existing computer functions are improved because data does not need to be pre-processed and converted by separate computer programs into structured data with known formats. Thus, computers implementing the methods to topic model using unstructured data perform faster and with less processing power. Additionally, processing unstructured data directly without first transferring/converting data to intermediary structured data further reduces required data storage for the systems described herein.

In addition, by implementing the vectors and clustering with the deepness and degree measure as described, the system extracts target and relevant data more accurately because mistakes based on sole frequency reliance is drastically reduced.

In addition, in some embodiments, the system includes an additional context module that may include a neural network trained to increase accuracy of context correlation for data items by the computer. In some embodiments, the accelerator provides a specialized processing chip that works in conjunction with the context module to compartmentalize the processing pipeline and reduce processing time and delay. Such accelerators are specialized for the system and are not found on generic computers.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for extracting targeted data using unstructured data, the method comprising:
receiving an unstructured data set, the unstructured data set including data items from a first source and a second source;
generating a first vector from the first source and a second vector from the second source, each vector including data items in the unstructured data set;
merging the first and second vectors to form a merged vector;
performing clustering, using a clustering algorithm, on the merged vector in order to produce a deepness measure and a degree measure for each data item in the merged vector;
generating a score for each data item in the merged vector using the deepness measure and degree measure of each data item; and
ranking each data item based on its generated score.

2. The method of claim 1, wherein the degree measure and the deepness measure for each data item are normalized.

3. The method of claim 2, wherein the normalized degree measure and deepness measure for each data item are power transformed before generating a score.

4. The method of claim 2, wherein normalizing the degree measure includes taking the log of the degree measure and then scaling the log of the degree measure by a max log value.

5. The method of claim 2, wherein the normalizing the deepness measure includes scaling the deepness measure to a percentage.

6. The method of claim 1, wherein the first source includes a global source of knowledge.

7. The method of claim 1, wherein the second source includes a personalized knowledge base.

8. The method of claim 1, wherein each vector is a multi-dimensional vector.

9. The method of claim 1, wherein performing clustering on the merged vector produces a tree data structure.

10. The method of claim 1, wherein data items include words.

11. A system for extracting targeted data using unstructured data, the system comprising:
one or more processors;
memory; and
one or more programs stored in the memory, the one or more programs comprising instructions for:
receiving an unstructured data set, the unstructured data set including data items from a first source and a second source;
generating a first vector from the first source and a second vector from the second source, each vector including data items in the unstructured data set;
merging the first and second vectors to form a merged vector;
performing clustering, using a clustering algorithm, on the merged vector in order to produce a deepness measure and a degree measure for each data item in the merged vector;
generating a score for each data item in the merged vector using the deepness measure and degree measure of each data item; and
ranking each data item based on its generated score.

12. The system of claim 11, wherein the degree measure and the deepness measure for each data item are normalized.

13. The system of claim 12, wherein the normalized degree measure and deepness measure for each data item are power transformed before generating a score.

14. The system of claim 12, wherein normalizing the degree measure includes taking the log of the degree measure and then scaling the log of the degree measure by a max log value.

15. The system of claim 12, wherein the normalizing the deepness measure includes scaling the deepness measure to a percentage.

16. The system of claim 11, wherein the first source includes a global source of knowledge.

17. The system of claim 11, wherein the second source includes a personalized knowledge base.

18. The system of claim 11, wherein each vector is a multi-dimensional vector.

19. The system of claim 11, wherein performing clustering on the merged vector produces a tree data structure.

20. A non-transitory computer readable storage medium storing one or more programs configured for execution by a computer, the one or more programs comprising instructions for:
receiving an unstructured data set, the unstructured data set including data items from a first source and a second source;
generating a first vector from the first source and a second vector from the second source, each vector including data items in the unstructured data set;
merging the first and second vectors to form a merged vector;
performing clustering, using a clustering algorithm, on the merged vector in order to produce a deepness measure and a degree measure for each data item in the merged vector;
generating a score for each data item in the merged vector using the deepness measure and degree measure of each data item; and
ranking each data item based on its generated score.
